(19) United States
(12) Patent Application Publication
(10) Pub. No.: US 2006/0284032 A1
(43) Pub. Date: Dec. 21, 2006

(54) A fabricated natural stone base coat rack

(76) Inventor: Athanasios Gliatis, Elmhurst, IL (US)

Correspondence Address: ATHANASIOS (TOM) GLIATIS, 388 MAPLE AVENUE, ELMHURST, IL, 60126, US

(21) Appl. No.: 11/160,264

(22) Filed: Jun. 16, 2005

(51) Int. Cl. A45D 19/04; F16M 11/00

(52) U.S. Cl. 248/127

(57) ABSTRACT

The enclosed drawings represent 3 different types of coat rack designs.

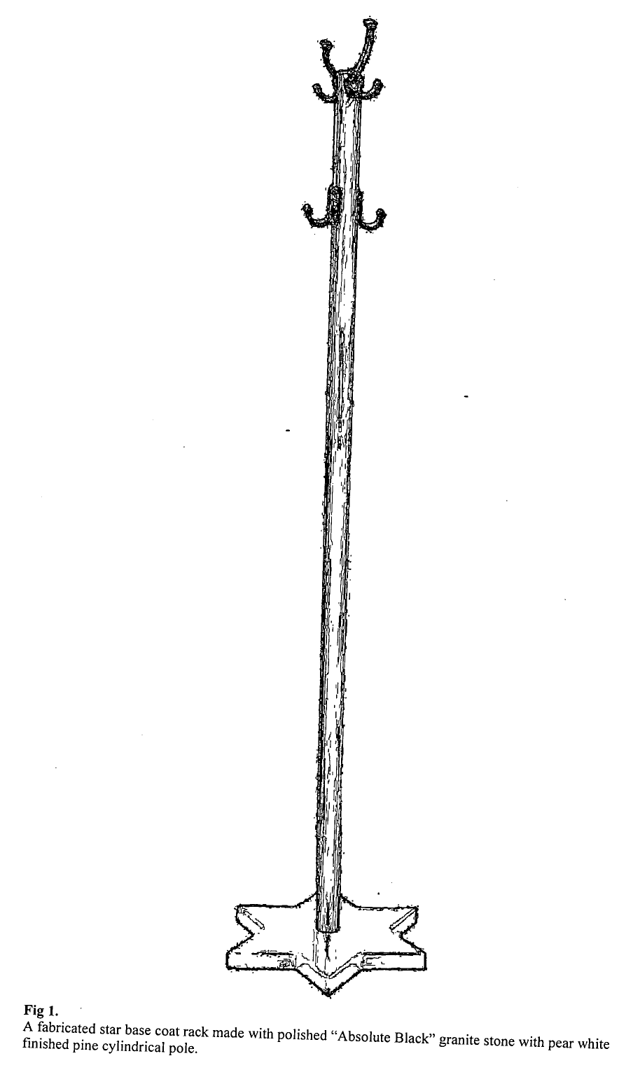

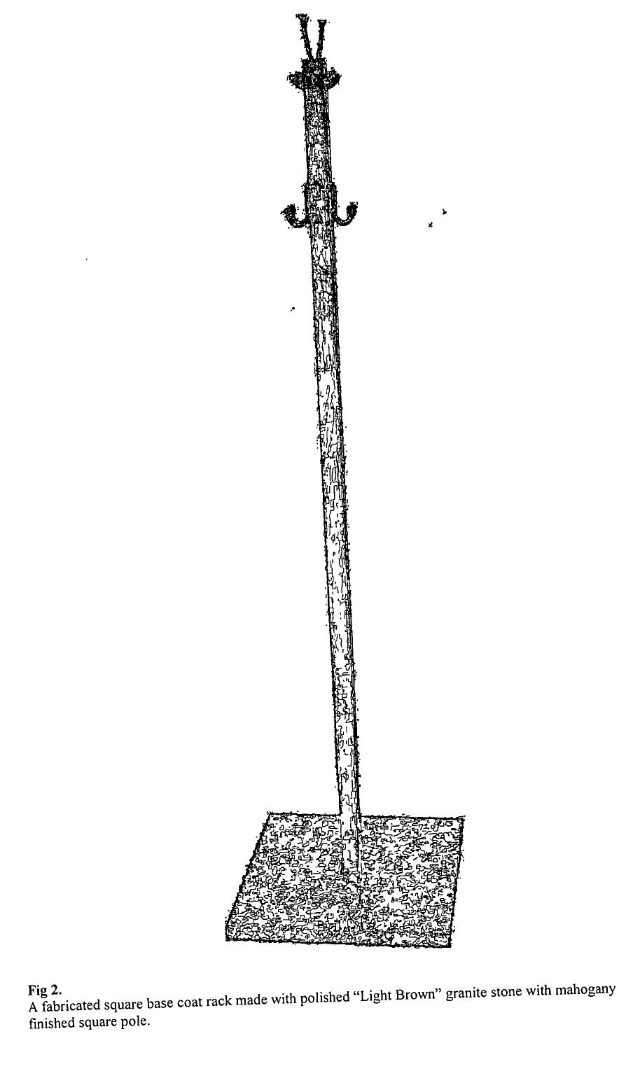

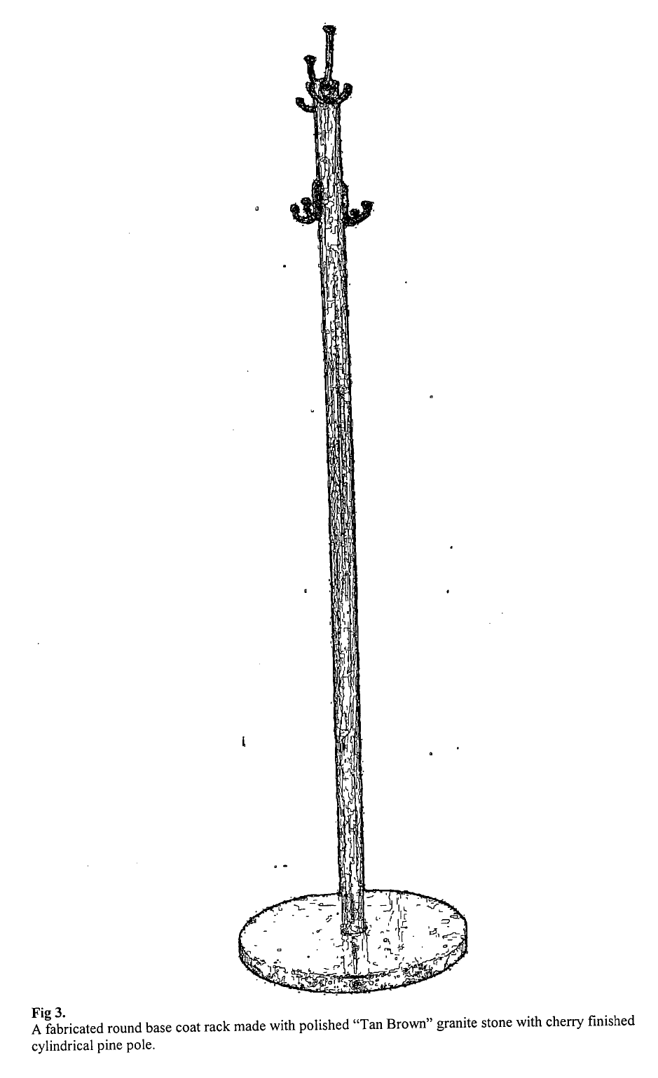

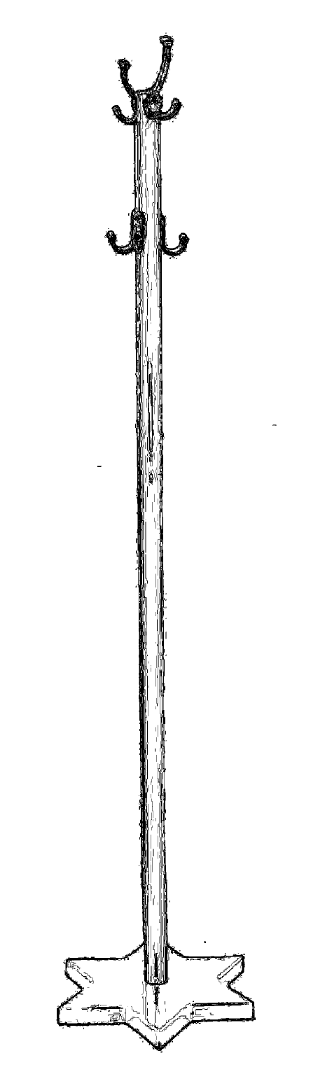

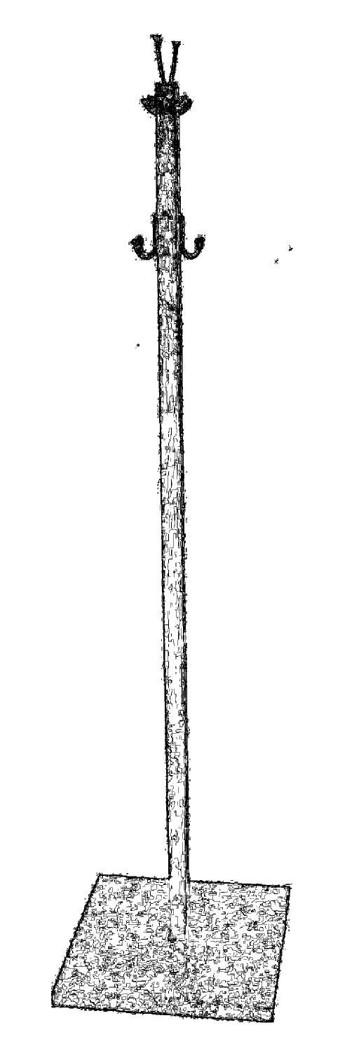

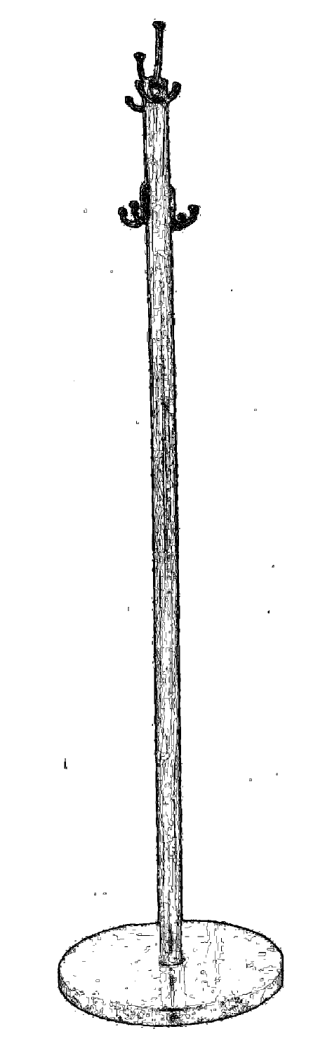

The 1^{st} one is made with Absolute Black polished fabricated star granite base with pear white pine cylindrical stem.

The 2^{nd} one is made with light brown fabricated polished square base granite with mahogany finished square prism stem. The last one and maybe the most popular is made with tan brown fabricated base granite and cherry finished cylindrical pine stem.

Small Cuts and Recycled Natural Stone Materials Usage

The proposed coat rack can utilize small cuts of natural stone materials.

A variety of natural stone bases include recycled oval vanity sinkhole cuts or small pieces to be fabricated as a coat rack's base.

Usage

The proposed coat rack can be used for home or office. In addition, it can be used as an accessory to compliment floors, vanities and granite kitchen countertops.

Mix and Match Pillars and Natural Stone Bases

An interchangeable variety of stem pillars (wood, metal) will match or contrast the base color and shape.

What is claimed is:

1. A geometric shape (square, circle, rectangle, triangle, oval, pentagon, hexagon, rhombus or star) natural stone (granite, marble, onyx, limestone) base 1.25 inches (30 mm) tall, 15 inches (38 cm) wide . . . but not limited to other sizes.

2. The fabricated natural stone base piece has a central hole formed through which the pillar rod is inserted.

3. A cylindrical or prism wooden or metallic stem pillar 1½ inches in diameter, 5-½ feet tall inserted into the center of the base 1 inch (25 mm) deep upright screwed in place from underneath or glued in place in the center position 1.25′ deep in the natural stone base.

4. Four different pairs of regular metal hooks. Two attached at the top and two attached 6-10 inches (15-30 cm) below the top of the pillar.

5. This coat rack can be built using a variety of mix and match natural stone bases and pillars to compliment the surroundings (furniture, decoration or floor) of the home or office.
